(19) United States
(12) Patent Application Publication
(10) Pub. No.: US 2004/0201222 A1
(43) Pub. Date: Oct. 14, 2004

(54) Power station utilizing potential energy of sea water pressure

(76) Inventor: Leonid Eylman, San Francisco, CA (US)

Correspondence Address: Leonid Eylman, 201 Turk Str. #716, San Francisco, CA, 94102, US

(21) Appl. No.: 10/314,978

(22) Filed: Dec. 10, 2002

(51) Int. Cl. H02P 9/04; F03B 13/10; F03B 13/12

(52) U.S. Cl. 290/53

(57) ABSTRACT

The main goal of the underwater power station is to produce a high pressure stream of water, which shoots up from a great depth to above the surface of the sea and which can be used to manufacture of electrical energy. Figure shows a cross-section of the above described station, which uses the potential pressure of deep sea water. The most important components of this station are a plunger 18 inside of main chamber 12 and a piston 48, which is attached to a plunger 18. Within the main chamber 12 are compressed air 44 and a spring 42. A piston 48 moves within a piston chamber 54. The surface of plunger 18 is 1a belled as 46 and the surface of piston 48 is 1a belled as 50. The ratio between these two surface areas is the coefficient of animation of the deep water pressure. Attached to piston chamber 54 is a hose 58 containing water under high pressure, which can be used to create electrical energy by any kind of turbine 68. Opening and closing the valves 32,40,50,56,66 create the work and the dummy actions of the underwater power station. A potential pressure of deep sea water pushes down plunger 18 during the work action. Forces of the decompressed spring 42 and buoyancy of a sunken buoy 72 act during the dummy action.

The deep sea power station uses a renewable sources of energy :1) the pressure of deep sea water and 2) the flowing nature of any liquids including the phenomenon of “flow in” (the arrows “m” illustrates this phenomenon) and the phenomenon of “flow out” (the arrows “n” illustrate this phenomenon). By using both phenomena the principle of the conservation of energy is upheld and we can receive the useful work results.

### FIELD OF THE INVENTION

The present invention relates to the field of power engineering, particularly to the renewal sources of energy.

### DESCRIPTION OF PRIOR ART

Efforts to reduce dependence upon fossil fuels as well as stringent environmental requirements with a regard to air pollution, etc has lead to an increasing demand for efficient and reliable generators of electrical power which can operate from the potential energy of sea water pressure.

Power generators driven by sea waves or streams are known in the art. Such sea waves paddle generator is described in old U.S. Pat. No. 578,001, Mar. 02, 1887, author A. Neynaber. Power generator driven by sea stream is described in the U.S. Pat. No. 4,403,154, Sep. 06, 1983, authors: Lucio V. Reale and William R. McKay. This list can be continued to a substantial number of Patents and literature sources.

An example of a power generator driven by the flow of water, sea stream or lunar tide is a conventional water-wheel or a special helical turbine, which are rotated by the flow or lunar tide wave. See the U.S. Pat. No. 5,929,531, Jul. 27, 1999, author William J. Lango. Although all the above-mention power generators which can be driven by the above-mention natural energy sources are known per se, power generator using the potential energy of sea water pressure does not exist.

### OBJECTS AND ADVANTAGES OF THE INVENTION

The object is to provide the generator of the above-mention type which has high efficiency of operation, the smallest overall dimensions, the simplest design and the low cost of electrical energy than any conventional sea waves, stream or lunar tide driven generators.

There are many renewal sources of energy such as wind, sea or river stream or sea waves. Such sources possess a kinetic energy. Therefore their utilization does not call any questions.

It is well known that a kinetic energy originates from a storage of a potential energy such as a potential energy of a compressed spring or a water pressure on the sea depth. If we can create the definite conditions then a potential energy of the sea deep water pressure can be transformed into a kinetic energy of the hydraulic plunger movement, which can be transformed into an electrical energy accordingly.

### DETAILED DESCRIPTION OF THE SUBJECT

The under water power station utilizing the potential energy of sea water pressure uses two well known natural physical phenomena, therefore it is necessary to explain the several physical principles.

### BACKGROUND

1. It is well known that in deep sea water great pressure exists. This pressure p has great unused potential energy P (see diagram of water pressure on FIG. 3a).

2. Any physical field is a source of energy. For example, the gravitational field of Earth is a source of gravitational energy. Any body placed in the gravitational field receives a gravitational energy, which can be stored (potential energy) or spent (kinetic energy).

3. It is well known that a gravity field can produce work. For example, a free falling body produces mechanical work and it has a kinetic energy W. Only in one case, however, can falling body produce useful work: if the kinetic energy W of the free falling body (in our device this is referred to as “work action”) creates more energy W than is needed for bringing the fallen body to the starting position-spends of energy A (in our device this is the “dummy action”).

4. The force of gravity is always in the downward direction and can be used during work action or dummy action as an extra dynamic force F.

5. It is well known that the stored potential energy P of free falling body is equal to the kinetic energy W of free falling body. The principle of the conservation of energy is upheld. (W=P)

It is known that W=m*V/2 and P=G*L. Hence, m*V/2=G*L, where m is a mass of body, V is a velocity of body, G is the weight of body, L is the height from which a body falls (its path).

Hence, in order for T ( the expenditure of energy during the dummy action) to be less than (the kinetic energy of work action), it is necessary to decrease the weight G or to decrease the height L , or both, after a body falls. When using a solid body, it is very difficult to do this. When using a liquid body, it is, however, possible to decrease the weight G and height L.

Illustration. If we use deep sea water pressure, which pushes down on the surface of a plunger 18 (FIG. 3), then a general force F rises. This force manufactures work. In order to return plunger 18 to its starting position, a quantity of energy equal to and more must be expended. The principle of the conservation of energy will be upheld, and no any useful work will result.

Falling liquid, flowing downward into a container, will increase in weight as the water lever in the container rises. The weight of water left in a container will decrease as liquid flows out. Hence, a liquid body possesses a phenomenon “flow in”, which increases a falling weight G of liquid body during work action and a phenomenon “flow out”, which decreases extracting weight G of liquid body during dummy action. Both phenomena are extra sources of energy. If we do not use the above phenomena, the process of work will die down, damping. If we use above phenomena, work will be converted in a continuous process. Hence, only a liquid body can be used for useful work.

6. It is also well known that the phenomenon of “flow in” exists for any liquid; that is, any liquid will flow into a container, if the liquid's level is higher than the edge of the container. See FIG. 1, Sketch A, left side, (arrows “m”), and Sketch D, left side or FIG. 3, left side.

When any liquid flows into any container, its center of gravity L must rise to new a position L and the beginning weight G of the liquid increases to the finishing weight G at every moment of work action. Thus, as a result of the phenomenon of “flow in”, the potential energy P increases. The difference between the finishing potential energy P and the beginning potential energy P is the kinetic energy of this work action K:

K=+(P−P) or K=+(G*L−G*L)

This phenomenon is an accumulator i.e. an integrator of potential energy. See FIG. 1, Sketch D, left side.

Let us assume, that the phenomenon of “flow in” absent. For example, the flowing liquid is placed in a hose 26 which has an edge higher than a level of sea.(See FIG. 2, Sketch E, left side). Clearly, the center of gravity will go down from the starting position L to the finishing position L, and the weight of liquid will go down from the starting position G to the finishing position G at every moment of work action. The difference between the finishing potential energy P and the beginning potential energy P is the kinetic energy of this work action K. Therefore the kinetic energy K′, which was used for manufacturing of the work action will decrease.

K′=−(P−P) or K′=−(G*L−G*L)

If we compared the kinetic energy of the work action K when the phenomenon of “flow in” exists and the kinetic energy of work action K′, when the phenomenon of “flow in” absent, then we will see, that K is much more then K′.

7. It is also well known that the phenomenon of “flow out” exists for any liquid, that is, any liquid will flow out of a container, if it is somehow forced over the edge of a container. See FIG. 1, Sketch B, right side, (arrows “n”), Sketch D, right side and FIG. 3, right side.

When any liquid flows out from a container, its gravity center L, must rise to new position L, because flow out will start when ever a very small change in the height of liquid body h in relationship to the height of the container occurs.

At this point, the three new forces will rise. At once a body of liquid is slightly above the edge of container, the first force of gravity will break the surface tension of the liquid and the process of “flow out” will begin. At this point, the second force of damping arises between the outside surface of liquid and the flowing liquid. The third force, which helps to create h, is buoyancy F, which creates by a buoy in sunken position. The extra third force acts on the block of the plunger-piston 18, 48. This forces lift up the water gravity weight G.

The difference T between the finishing potential energy P, and the beginning potential energy P is:

T=+(P−P) or T=+(G*L−G*L)

T—means the expenditure of energy for dummy action.

This phenomenon disperses a liquid and decreases the potential energy of dummy action water column. Hence, the expenditure of energy for dummy action decreases accordingly.

Let us assume that the phenomenon of “flow out” is absent. For example, the extracted liquid is placed in a hose 28, which has an edge much higher than a level of sea. See FIG. 2, Sketch F, right side and Sketch H, right side.

Clearly, the starting center of gravity L will go up to the finishing position L and the starting weight of extracted liquid G will go up to finishing weight G.

Therefore the expenditure of energy T, which is needed for the extracting water from main chamber 12 during a dummy action, will increase at every moment during the dummy action.

T′=−(P−P) or T′=−(G*L−G*L)

If we compared the energy extended T during a dummy action when phenomenon of “flow out” exists and when phenomenon of “flow out” is absent, then we will see that T′ much greater than T.

If we compared the kinetic energy K′, which is used for a work action and the energy expenditure T′ for a dummy action, then we will understand that any useful work can not produced, because energy expenditures T′ of a dummy action greater than energy K′, which produce by a work action.

Hence, the useful work can be produced only, if we uses both the phenomena of “flow in” and of “flow out”

8. If we use the phenomenon of “flow in” during a work action and the phenomenon of “flow out” during of a dummy action, then the principle of conservation of energy will be upheld and we can write:

=m*V/2, where m*V/2 is kinetic energy K which we can use for an useful work and partly for a dummy action.

It is well known that useful work is the difference between a forward (work action) action and a backward (dummy action) action in an energy transformer mechanism. As a result of above phenomena we have a periodical continuous process.

Note. If the hypothetic water column 4 (See FIG. 1, left side, G) moves down, it will develop a gravitational force F, as will freely falling solid body. Solid bodies, however, do not have either the “flow in” or “flow out” phenomenon. Thus, if a solid body is dropped from any height: P=P, hence =m*V/2=0.

9. It is well known that water in the abstract an incompressible liquid.

10. It is also well known that the water pressure p in the bottom of one vessel will be the same as that in the bottom of the second communicating vessel. In this invention, both (the point of connection between the main chamber and the outside water) are at the same depth under the sea and have a equal water pressure.

11. Any work complete in the first of two communicating vessels, will also be completed in the second vessel and will be equal measure.

12. In our case, a loaded portion of water flows into the main chamber 12, and an unloaded, uncompressed portion of water flows out of a container (the main chamber 12 and a hypothetic hose 8). In other words, we use the potential energy of a compressed portion of water for work action and remove the same volume of an uncompressed portion of water during a dummy action. The general quantity of the compressed portions of water does not decrease, because the gravity field restore it. We, therefore, can use the naturally renewing source of energy: the Earth gravity field.

13. See FIG. 1, Sketch C, which shows the transference of water portion inside of the main chamber 12 during work and dummy actions. The work action (FIG. 1, Sketch C, left side is not performed at the same time as the dummy action ( FIG. 1, Sketch C, right side).After the work action is finished, the dummy action begins.

See FIG. 1, Sketch D, which shows a diagram of the general quantity of water used per the work action 22 and the quantity of water which has risen during the dummy action 24. The height of the hypothetical water column, which forms during the work action is much greater than the height of water column, which is rises during the dummy action. At every moment of working action, the hypothetical column of water again fills up (the phenomenon of “flow in” works. See FIG. 1, left side of Sketch D). At every moment during the dummy action, the hypothetical water column drops (the phenomenon of “flow out” works. See FIG. 1, right side of Sketch D). The difference of the columns heights defines the useful work, because the heights are proportional to potential energy. FIG. 2, Sketch H shows the situation when both above phenomena is absent. The water column height into hose 26 drops (left side of Sketch H) and the water column height into hose 28 rises (right side of Sketch H) The work action can not manufacture more energy than the expenditures of energy during of the dummy action

### BRIEF DESCRIPTION OF DRAWINGS

FIG. 1. Schematic of the Work and Dummy Action of a Hypothetical Column of Water, Using the Phenomena of “Flow In” and “Flow Out”

Sketch A—Work Action. The main chamber 12 has not a hose. Potential energy is increased.

2 level of sea

4 hypothetical water column of work action

6 cone-shaped cavity in the water. See the illustration by the arrows “m”

Sketch B—Dummy Action. The main chamber 12 has not a hose. Potential energy is decreased.

8 hypothetical water column of dummy action

10 convex surface of water protrudes above the edge of container. See the illustration by the arrows “n”

Sketch C—Two Position of Main Under Water Chamber. Left position shows a work action, right position shows a dummy action.

12 main under water chamber

14 entrance in main chamber

16 exit from main chamber

18 plunger at time of a work action

20 plunger at time of a dummy action

Sketch D—Diagram which shows the change of the heights of the hypothetical water columns 4 and 8 during work and dummy actions accordingly.

Left the height of hypothetical water column is a result of the work action. It consists from two parts of the heights: one part of the height 4 determines by the depth of immersion, the other part is the accumulated height of water during work action 22. See left side of Sketch D: this phenomenon shows by the arrows “m”

22 portion of water, which flows into the main chamber 12 (the hatch marks show portion of water).

Right the height of hypothetical water column is result of dummy action. It consists from two parts of heights: one part of the height 4 determines by the depth of immersion, the other part 24 is the dispersed height h of water column 8. See right side of Sketch D: this phenomenon shows by the arrows “n”

FIG. 2. Schematic of the Work and Dummy Action of a Real Column of Water Confined within a Hose), which Both do not Use the Phenomena of “Flow In” and “Flow Out”

Sketch E—Work Action. The main chamber 12 has a hose 26. Inside of a hose 26 the height of water column decreases at every moment of a work action. Hence, potential energy of real water column is decreased.

Sketch F—Dummy Action. The main chamber has a hose 28. Inside of a hose 28 the height of water column increases at every moment of a dummy action. Hence, potential energy of real water column is increased.

Sketch G. Two Position of Main Chamber 12. Left position shows a work action, chamber 12, which has a hose 26. Right position shows a dummy action, chamber 12, which has a hose 28.

Sketch H—Diagram which shows the change of heights of the real water columns inside of the hoses 26 and 28 during work and dummy actions.

The real water column decreased its height of water during work action. See FIG. 2, left side. The right real water column increased its height of water H during a dummy action, because water retains inside a hose 28. See FIG. 2, right side.

Compare a size of h and a size of H.

FIG. 3. Schematic View of a Cross-section of the Under-Water Power Station

FIG. 3a shows a diagram of the depth water pressure.

The list of details to the under water sea power station.

30 bar

32 outlet valve

34 unit for bracing bar 30

36 extracted portion of water during the second period of a dummy action

38 extracted portion of water during the first period of a dummy action

40 inlet valve

42 spring

44 air or any gas

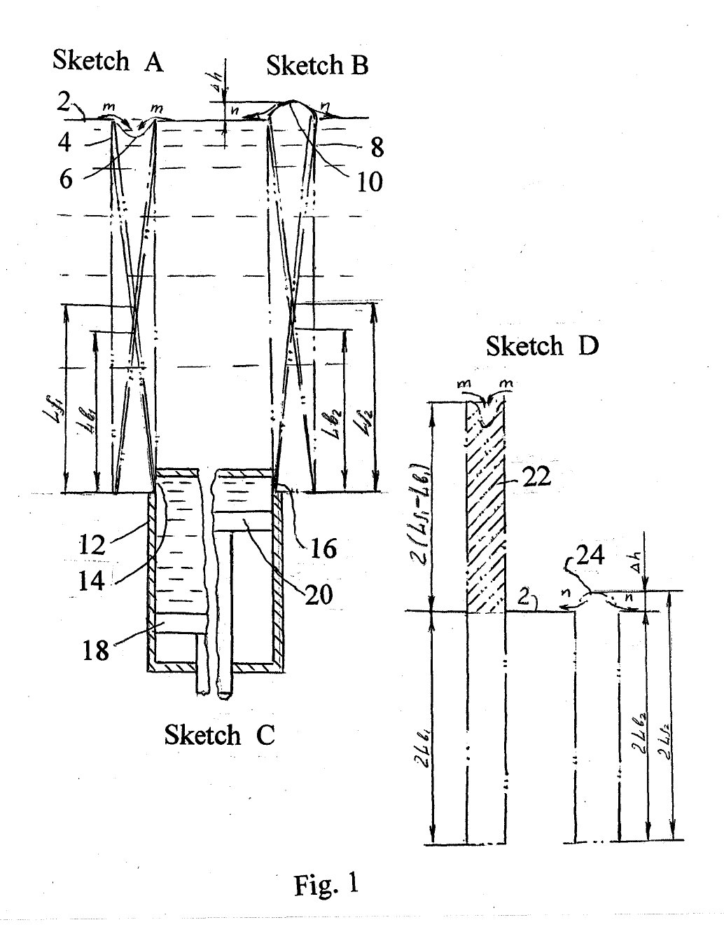

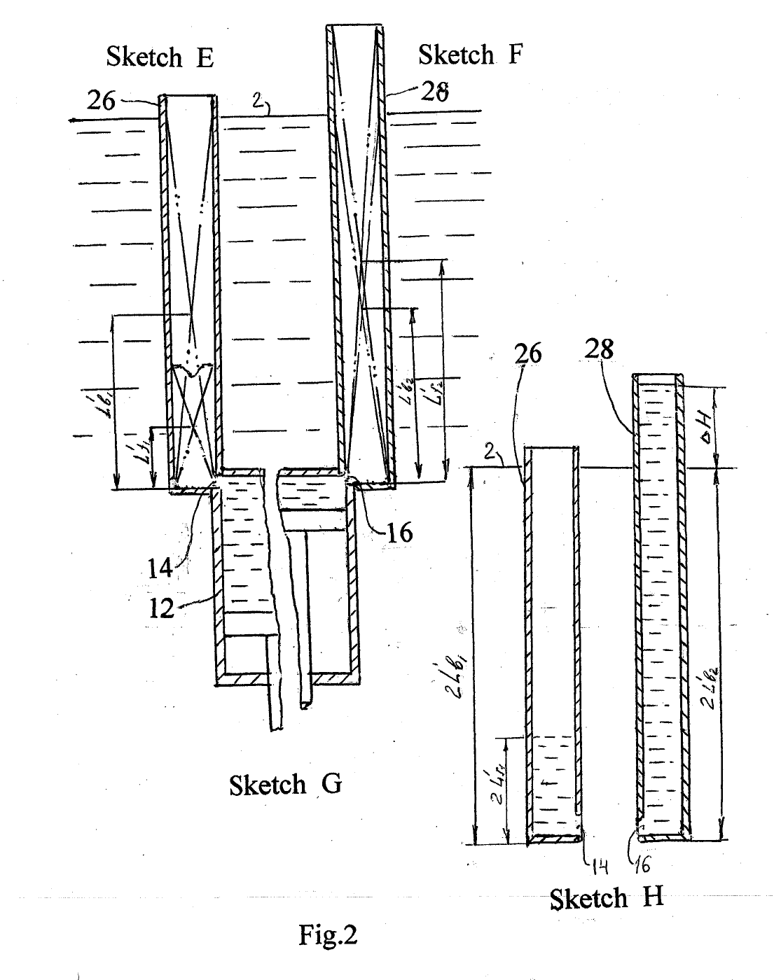

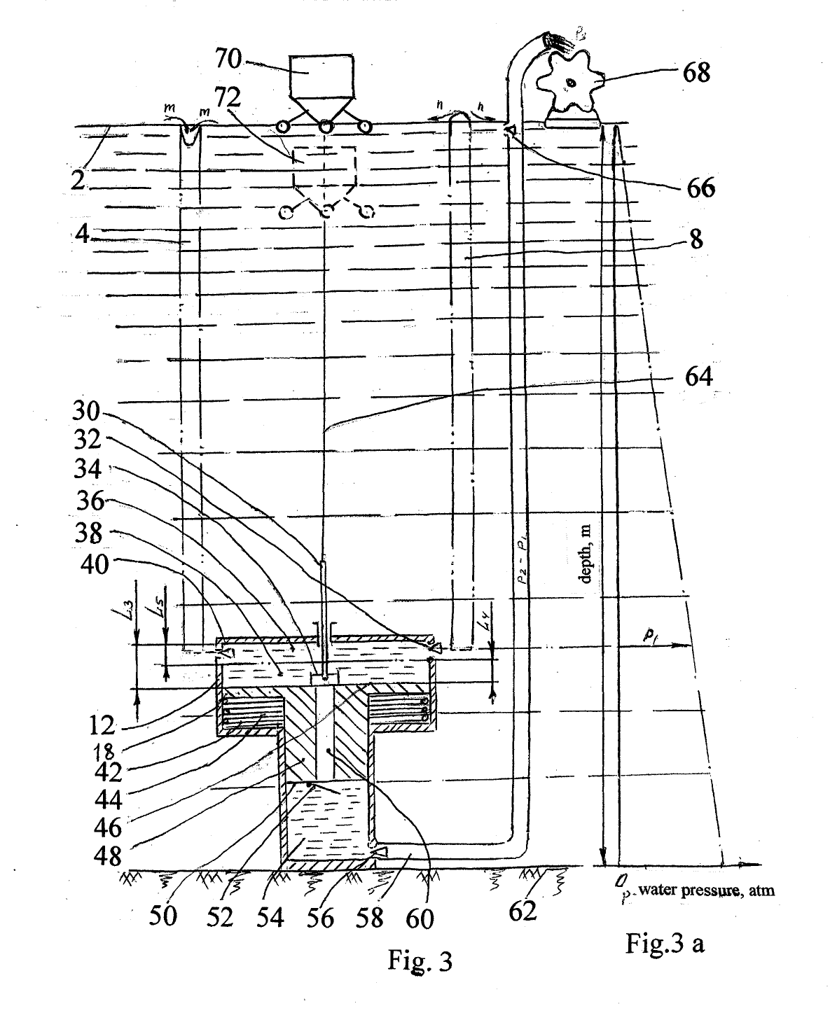

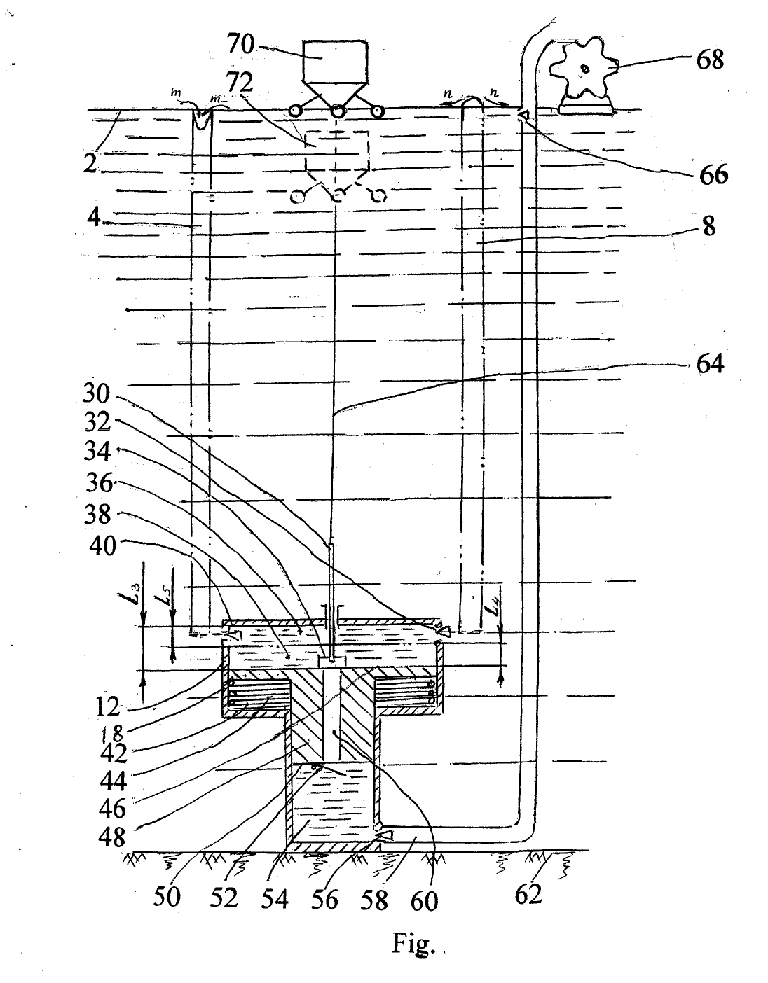

46 surface of plunger S (See FIG. 1, positions of plunger 18,20)

48 piston

50 surface of piston S

52 plate valve

54 piston chamber

56 work valve

58 hose for a high water pressure

60 channel between main chamber 12 and piston chamber 54

62 bottom of sea

64 tow-line

66 compensate valve

68 device (any kind turbine) for converting mechanical energy into electrical energy

70 buoy in emerge position

72 buoy in sank position

Symbols:

G beginning weight of the hypothetical column of sea water before work action.

G finishing weight of the hypothetical column of water after work action.

G beginning weight of the hypothetical column of sea water before dummy action.

G finishing weight of the hypothetical column of water after dummy action.

G weight of the hypothetical column of water 22, which enters to the main chamber 12

G part of weight G which must be passed trans plate valve 52 into the piston chamber 54 during the first period of dummy action.

G part of weight G which must be passed trans outlet valve 30 during the second period of dummy action

L beginning size of the center of gravity of the hypothetical column of water before work action.

L finishing size of the center of gravity of the hypothetical column of water after work action.

L beginning size of the center of gravity of the hypothetical column of water before dummy action.

L finishing size of the center of gravity of the hypothetical column of water after dummy action.

L general displacement of the plunger 18

L displacement of the plunger 18 as result of the first period of dummy action.

L displacement of the plunger 18 as result of the second period of dummy action.

h displacement of the hypothetical water column as result of the second period of dummy action.

H displacement of the real water column inside of hose 24 as result of the second period of dummy action

S flat area 46 of the plunger 18

S flat area 50 of the piston 48.

C=S÷S is coefficient of animation.

g is the acceleration of gravity; g=9.81 m/sec

p is sea deep water pressure. See FIG. 3a.

p is high water pressure; p=p*S÷S

p is work water pressure; p=p−p

K is kinetic energy.

P is potential energy

T is expenditures of energy during dummy action

F is general force of water pressure, which acts on flat area of plunger 18:F=p*S

F is force of gravity of falling water

F is buoyancy of buoy or pontoon

F is buoyancy of a block of plunger 12 and piston 48

F is air decompressed force and decompressed spring force

F is force of water pressure, which acts on flat area 50 of piston 48; F=p*S

### DESCRIPTION OF THE UNDER WATER POWER STATION

FIG. 3 shows a cross-section the under water power station. The main goal of above station is to produce a high pressure water stream, which can be higher than the surface of sea. Kinetic energy of such stream can be used for manufacturing electrical energy. The under water power station uses the potential pressure of deep sea water, which depend from depth its immersion. See FIG. 3a the diagram of a relation between a water pressure and a depth of water power station immersion.

The most important components of the under water station are described below.

A plunger 18 inside of a main chamber 12. Within a main chamber 12 are an air 44 and a spring 42. A piston 48 is attached to a plunger 18, which moves within a piston chamber 54. A plunger 18 and a piston 48 have a channel 60, which closes by a plate valve 52. When a piston 48 pushes water down a plate valve 52 closes and it opens when a piston 48 moves up. Attached to a piston chamber 54 is a hose 58 at high water pressure. This high water pressure can be used to create electrical energy by any kind turbine device or any other device 68 for this goal. A main chamber 12 has an inlet valve 40, which allows sea water to enter inside and an outlet valve 32, which allows used water to leave the main chamber 12. A piston chamber 54 has a work valve 56, which allows sea water at high water pressure to exit inside a hose 58. A plunger 18 is attached to a bar 30 by an unit for bracing bar 34 and a tow-line 64, which has a specific length. This length can allow a plunger 18 to move without sinking of a buoy 70 on part of its way. A buoy or pontoon has two position: in a sunken position 72 and in a re-surfaced position 70.

The deep sea power station uses the following natural forces. A potential pressure of deep sea water p which rises the force F. Force F=p*S, where S is a surface of plunger 46. The force of gravity F of falling water column 4. A buoyancy F rises, when a buoy is in a sunken position 72. Extra buoyancy F rises when a block of plunger 12 and piston 48 moves up during dummy action. A decompressed spring 42 and a decompressed air 46 rise force F, which moves up a block of plunger 12 and a piston 48 during dummy action

The deep sea power station uses the flowing nature of any liquid to create a movement: the phenomenon of “flow in”. (See FIG. 1, Sketch A in details. The arrows “m” illustrates this phenomenon) and the phenomenon of “flow out”. (See FIG. 1, Sketch B. The arrows “n” illustrates this phenomenon).

### DESCRIPTION OF WORK

A process of work has two periods: working action and dummy action.

Working action.

The working action of the mechanism under water station is as follows:

We open the valve 40 and sea water rushes into the main chamber 12 forcing the plunger 18 down. See FIG. 1, Sketch A and D. Because the surface area S (46) of the plunger 18 is relatively greater than that of the piston 48 surface area S (50) the force F of the pressure of the deep water p and the dynamic force F. Both forces (F+F) create a common force, which is greatly multiplied by the differential sizes of these plunger 18 and piston 48. Only part of the hypothetical water column 4 enters to the chamber 12. It is part 22. Thus at once plunger 18 is pushed down, the plate valve 52 is closed and valve 56 is opened, then water in the piston chamber 54 is forced out and up by the hose 58 to the device 68, which generates electrical energy. The device 68 is any kind turbine or a paddle mechanism.

Notes for work action.

1. The plate valve 52 is closed during all work action.

2. The work valve 56 is opened during all work action.

3. The outlet valve 32 is closed during all work action.

4. The water volume of main chamber 12 cavity 22 is V=S*L) or V=G where is specific weight of water.

The manufactured mechanical energy K during work action can be calculated as follows:

K=K+K, where K=F*L; and K=F*L

Where K is the static mechanical energy from the static acting force F on the flat plunger 18 area 46. F=p*S We do not take in account the energy for a compression of an air 44 and a spring 42, any friction loses, and buoyancy of buoy in the first moment of a movement.

Where K is the dynamic force. Dynamic force arises so result waterfall G on height L−L.

Dummy action.

The dummy action can be continuous in two periods; the first period and the second period.

The first period.

1. The plate valve 52 is opened.

2. The inlet valve 40 is closed.

3. The outlet valve 32 is closed.

4. Because both valves 32 and 40 are closed, the outside water pressure p is zero inside of the main chamber cavity 12 and a part of the water volume 38 can going to the piston chamber 54 freely (through the channel 60 and the plate valve 52, the phenomenon of “flow in” occurs inside the main chamber cavity 12 and the piston chamber cavity 54), when both the plunger 18 and the piston 48 move upward.

5. The dummy action can be limited by the first period without the second period, but in this case, an extracting water will less. If we have the coefficient of animation C equal 1, i.e. the diameter of plunger 18 is coequal to the diameter of piston 48, i.e. S=S, then, in this case, the work water pressure can not be varied and p=p Hence, it is not necessary in the second period.

The second period.

1. The plate valve 52 is closed.

2. The inlet valve 40 is closed.

3. The outlet valve 32 is opened.

4 The work valve 56 is opened.

5 The compensate valve 66 is opened and it allows water to flow into hose 58.

We have the following forces for both periods of dummy action. F-air decompressed and spring decompressed forces; two forces of buoyancy F and F; F-force of water pressure p which acts on the piston 48: bottom surface 50.

The first period. The force F so result of re-surfaced of buoy 72 to position 70 and the second F of re-surfaced a block of plunger 18 and piston 48; F is the static force so result of water pressure on piston bottom 50, which rises when the valve 66 and 56 are opened

The dummy action of the mechanism is as follows. If we close valves 40 and 32, the forces F, F, F can move the piston 48 and plunger 18 up because outside water pressure p is not acting on the block of plunger 18 and piston 48 and the plate valve 52 opens. Inside water will rush into the piston chamber 54. In the main chamber 12 the displaced volume 38-V must be calculated by formula: V=S*L. The main chamber 12 can loose only the water volume V. Residual volume 36 is V. V=S*L. So V>V therefore a part of water 22 of the main chamber 12 must be extracted through the valve 32 during the second period of dummy action.

The second period.

When we opens the valve 32, then a outside water pressure p rises in the chamber 12 and, hence, the force F acts again. When we open the valve 66 and valve 56, then force F rises. Besides, in this case, we use the phenomenon of “flow out”. See FIG. 1, Sketch B and Sketch D, which decreases the expenditures of energy.

The waste energy is small during dummy action for both periods of the extracting water from the main chamber 12.

The expenditures of energy during dummy action T can be calculated as follow:

T=T+T, where T=F+F+F)*h*t

Where T is energy expends for the removal of water volume 38 (weight G of water), which is extracted during the first period of dummy action. In this time the phenomenon of “flow in” uses in the chamber 12. So result of this phenomenon the weight G freely leaves the chamber 12, therefore energy expenses is very small T=F*L.

Where T is energy expenditures for the displacement of water volume 36 (weight G of water), which is extracted during the second period of dummy action. In this case, the outlet valve 32 is opened and water pressure p acts on the plunger surface S, ( 46 ). Therefore total of all forces (F+F+F) must act for lifting the block of plunger 18 and piston 48. So result of their actions is the displacement h of water hypothetical column 8. See FIG. 1, Sketch B. Time t depends from dimensions of valve 32 hole. Because a height h is very small therefore T expenditures are small too.

(Compare a size of h, FIG. 1, Sketch B and a size of H, FIG. 2, Sketch H)

1. A method for converting the potential energy of the deep-water pressure into kinetic energy by means of the movement of a hydraulic multiplication block, which has plunger and attached piston within an under-water chamber comprised of the following natural phenomena, various pieces of the equipment, work, and dummy action:
the work action accompanies by the phenomenon of “flow in”, which start when the level of any liquid body is lower than the level of a receiver vessel (in this case, the main under-water chamber), which happens spontaneously, and which accumulates water, hence, the potential energy at every moment during the work action;
the dummy action accompanies by the phenomenon of “flow out”, which starts when the level of any liquid body is higher than the level of the liquid in the receiver vessel and liquid can flow out, but the phenomenon of “flow out” requires energy from an outside source of energy: of the sunken buoy, pontoon, or the spring mechanism and which disperses of the water height, hence, the potential energy at every moment during the dummy action;
an under-water main chamber, which must be sunken to a depth, where enough water pressure exists for the work, and it must contain the said moving plunger with attached piston, which moves within a piston chamber and multiplies the water pressure to work the value, and both said plunger and said piston must have a channel with a plate valve for passing a part of portion of the water from the main chamber into the said piston chamber during the dummy action;
the work action starts because the inlet valve of said main chamber opens and the outlet valve closes and the deep water pressure and the dynamic force of the moving water portion—both pushes said block of said plunger-piston down which is accompanied by the phenomenon of “flow in”, which increase the quantity of energy;
the dummy action starts when the inlet valve closes, the outlet valve opens, and buoyancy, the spring force, and the air decompressed air force—can all move the block of the plunger-piston up for extracting the used water from main chamber, which is accompanied by phenomenon of “flow out”, which decreases the energy expenditure for the dummy action;
the sequence of the work action and the dummy action converts the potential energy of the deep-water pressure into kinetic energy of said multiplied water pressure stream, which can be used for manufacturing electrical energy.

2. A under-water power station for converting the energy of deep-water pressure into kinetic energy, which uses the method of claim 1 comprised of:
a hydraulic mechanism in the said main and piston chambers for multiplying sea water pressure into water pressure work, which is at least 1 to 10 times and more times greater that the pressure of the naturally occurring water-pressure at any given depth;
any kind transducer for converting water pressure work into electrical energy;
means for extracting used water from said main chamber: the block of said plunger and piston, the system of valves and a buoy or pontoon lifting mechanism with a rod, a tow-line or a spring lifting mechanism.

3. The closure of claim 2 wherein said plunger can be acted in the direction of the water pressure or at any angle to it for the work action and the against direction of the work action for the dummy action.

4. The closure of claim 2 wherein said plunger can not move without the presence of air or some kind gas in the said main chamber, which is compressed or decompressed in accordance with direction of the movement of the said plunger.

5. The closure of claim 2 wherein said valves can be operated by electrical, by mechanical or by other means and said valves can be any kind valve systems.

6. The closure of claim 2 wherein said power station can consist of two or more said under-water chambers within one installation.

7. The close of claim 2 wherein said power station can use one or more electrical generators of any kind.

8. The closure of claim 2 wherein said power station can use one or more hydraulic turbines of any kind.

9. The closure of claim 2 wherein the said plunger and the said buoy or pontoon must be of a size which must be coordinated with the plunger movement and a specific length of the tow-line of the buoy lifting mechanism so that this length does not allow the buoy to straight away sink into the sea after during a work action and a portion of the buoy's pathway will be above water and thus not affected by the force of buoyancy.
